(19) United States
(12) Patent Application Publication
(10) Pub. No.: US 2025/0303302 A1
(43) Pub. Date: Oct. 2, 2025

(54) USER PLACEMENT FOR MULTI-APPLICATION HOST COMPUTING INSTANCE GROUPS

(71) Applicant: Amazon Technologies, Inc., Seattle, WA (US)

(72) Inventors: Jian Luan, Kirkland, WA (US); Henry Liang Goffin, Seattle, WA (US); Dajun Dian, Redmond, WA (US)

(21) Appl. No.: 18/620,648

(22) Filed: Mar. 28, 2024

(51) Int. Cl. A63F 13/52; A63F 13/493

(52) U.S. Cl. CPC A63F 13/77; A63F 13/355

(57) ABSTRACT

An application streaming service may receive, from a customer, one or more requests to link a plurality of different applications to a host computing instance group for hosting execution of the plurality of different applications. The application streaming service may allow a customer to receive one or more video streams from one or more of the plurality of applications via a customer interface. The application streaming service may allow any of the plurality of different applications to be loaded onto any host computing instance in the host computing instance group at any time that there is sufficient on-host size availability. The application streaming service may place users onto application instances based on a set of user placement priorities. The application streaming service may transmit video streams captured from one or more application instances of one or more of the plurality of different applications to one or more users.

### CROSS-REFERENCE TO RELATED APPLICATIONS

This application is related to the following application, which is hereby incorporated by reference in its entirety: U.S. patent application Ser. No. 18/620,503 filed Mar. 28, 2024, entitled “APPLICATION STREAM PREVIEWING” (Attorney Docket Number: 101058.001335). This application is also related to the following application, which is also hereby incorporated by reference in its entirety: U.S. patent application Ser. No. 18/620,597 filed Mar. 28, 2024, entitled “MULTI-APPLICATION HOST COMPUTING INSTANCE GROUP FOR APPLICATION STREAMING” (Attorney Docket Number: 101058.001343).

### BACKGROUND

An application streaming service may execute applications and stream video, and optionally audio, from the applications to remote users. The remote users may provide input for interacting with, and controlling, the remote applications. One common example of this is the video game context, in which a streaming service may execute video game applications and stream game video to remote game players. The game players may then provide input to the remotely executed games, such as input for moving and controlling a character within a game. The application streaming service may execute and stream the applications on behalf of customers, such as video game developers that create video games.

### BRIEF DESCRIPTION OF DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a diagram illustrating an example stream preview system for a single application that may be used in accordance with the present description.

FIG. 2 is a diagram illustrating an example stream preview system for multiple applications that may be used in accordance with the present description.

FIG. 3 is a diagram illustrating example user placement priorities for a multi-application host computing instance group that may be used in accordance with the present description.

FIG. 4 is a diagram illustrating a first example user placement for a multi-application host computing instance group that may be used in accordance with the present description.

FIG. 5 is a diagram illustrating a second example user placement for a multi-application host computing instance group that may be used in accordance with the present description.

FIG. 6 is a diagram illustrating a third example user placement for a multi-application host computing instance group that may be used in accordance with the present description.

FIG. 7 is a flowchart illustrating an example stream previewing process that may be used in accordance with the present description.

FIG. 8 is a flowchart illustrating an example application streaming process for a multi-application host computing instance group that may be used in accordance with the present description.

FIG. 9 is a flowchart illustrating an example user placement process for a multi-application host computing instance group that may be used in accordance with the present description.

FIG. 10 is a flowchart illustrating an example application instance selection process for user placement for a multi-application host computing instance group that may be used in accordance with the present description.

FIG. 11 is a diagram illustrating an example system for transmitting and providing data that may be used in accordance with the present description.

FIG. 12 is a diagram illustrating an example computing system that may be used in accordance with the present description.

### DETAILED DESCRIPTION

Techniques for application stream previewing and multi-application host computing instance groups are described herein. The described techniques may be employed in a variety of environments, for example including execution of applications (e.g., video games) on host computing instances operated by a cloud-based application streaming service. The host computing instances may be operated on behalf of customers of the application streaming service, for example application developers (e.g., video game developers). The application streaming service may be a multi-tenant service, meaning that it may operate host computing instances on behalf of multiple tenants/customers.

The techniques described herein may provide a feature referred to as stream preview, in which customers of the application streaming service may view and interact with a streamed application before the application is made publicly available. This may allow the customer to observe and test how the application behaves while the application is executed by a host computing instance of the application streaming service, which may be the same execution platform that is eventually used to execute and stream the application to the public. The customer may therefore detect, and potentially correct, errors, problems or other unwanted features before the application is made publicly available. For example, stream preview may allow customers to test and interact with games before the games are made available to the general public. Because stream preview sessions may be executed on the same cloud platform as sessions of the eventual released application, the performance between stream preview sessions and released application streaming sessions may be the same. Thus, customers of the application streaming service can mimic the exact experience of the eventual end users via stream preview. This allows for accurate testing and analysis of how the applications are streamed before they are released.

In some examples, the application streaming service may allow the customer to view and interact with the application through the same interface (e.g., a service console interface) that the customer may use to configure a group of host computing instances for streaming of the application. Additionally, in some examples, customers may use stream preview to demo applications to their clients and make further modifications to their applications based on their clients' feedback before the application is released. Customers may access and test their applications using stream preview with minimal settings required, using cloud platforms without provisioning their own hardware. Customers may also be able to switch between different applications and view metrics collected from the stream preview sessions.

Some conventional pre-existing techniques may allow an organization to setup and configure a website and a backend (e.g., a server) to view and interact with an application stream before the stream is made available to the public. However, these techniques may be disadvantageous for several reasons. For example, when using these techniques, a customer may setup a website to hold the application stream. Additionally, the customer may setup a backend and may configure the backend with credentials to call a streaming service interface, such as a streaming service application programming interface (API). Thus, the customer may spend time and effort to setup a website and backend as described above. By contrast, the stream preview techniques described herein may provide an application stream to authorized users of the customer interface (e.g., portal interface). Thus, the customer is not required to setup and configure their own website and/or backend in order to receive a stream captured from an application executed on resources of the streaming service.

Another feature described herein is a multi-application host computing instance group for application streaming. A host computing instance group, as that term is used herein, refers to a group of one or more computing instances to which one or more applications are linked for the purpose of hosting execution of the one or more applications. A host computing instance group may enable customers to configure streaming parameters for an application, for example by allowing customers to set parameters of the host computing instance group, such as a hardware configuration, a maximum number of concurrent streams, and other parameters. The multi-application host computing instance group allows a customer to link a plurality of different applications to a single host computing instance group. For example, a customer may link a plurality of different video game titles to the same host computing instance group. In one specific example, the customer may link a car racing game, a war combat game, and a football game all to the same host computing instance group. This is a contrast with some conventional techniques, in which only a single application could be linked to a single host computing instance group. It is noted that the term different application, as used herein, may refer to both different application titles (e.g., a car racing game and a war combat game) as well as different versions (e.g., development updates/iterations) of a single application title. Thus, in some examples, a multi-application host computing instance group may include multiple different versions of a single application title. It is also noted that the term version, as used herein, may include any updated iterations of an application, regardless of whether the update receives a new version number relative to a prior update.

The ability to link multiple different applications to a single host computing instance group may provide a number of advantages to customers. For example, a multi-application host computing instance group may reduce the amount of time required to deploy new applications for streaming. In some examples, the creation of new host computing instance groups for application streaming may be a time-consuming process, such as due to the time required for customer configuration of the host computing instance groups, the time required for new host computing instances to be launched, the time required for machine instance generation, and other associated operations. Thus, multi-application host computing instance groups may reduce deployment time for new applications, such as by reducing the amount of host computing instance groups that are created and/or by allowing new applications to be linked to an already existing host computing instance group. Additionally, multi-application host computing instance groups may reduce the amounts of host computing instances that are needed to execute streamed applications, thereby resulting in cost savings for customers. In particular, each host computing instance group may require at least one backing host computing instance group. Moreover, while customers may have the ability to scale-down a host computing instance group during periods of lower demand, the customers may often forget, or may otherwise be unable, to do this. Furthermore, by reducing the overall quantity of host computing instance groups that are employed by a customer, multi-application host computing instance groups may reduce the complexity and time required to manage all of the host computing instance groups that are employed by the customer.

In some examples, a multi-application host computing instance group may allow stream previews to be provided of multiple different applications using only a single host computing instance group. This may be particularly advantageous for testing of an application via stream preview, for example because it may allow a customer to make updates and changes to an application while testing, such as based on the customer's interactions with a stream preview of the application. The customer may then, for example, create an updated version of the application that incorporates the changes made based on stream preview. This updated version of the application may then be added to an existing host computing instance group. The customer may then quickly initiate a stream preview of the updated version of the application, without having to wait for a new host computing instance group to be created. This may reduce the overall time required to test, update and re-test an application prior to exposing a finished version of the application to the public. Thus, by combining stream previewing with multi-application host computing instance group functionality, a customer may be able to preview, and optionally switch between, multiple application titles and/or application title updates without the need to spend time creating, configuring and managing multiple host computing instance groups.

In some examples, a set of user placement priorities may be employed for a multi-application host computing instance group, such as to reduce the amounts of total active applications and active host computing instances that are operated within the multi-application host computing instance group. Reducing the amount of active host computing instances within a host computing instance group may result in a cost savings to the customer. In some examples, a request may be received for application instance placement for a user for a first application of a plurality of different applications linked to a host computing instance group. Additionally, in some examples, the user placement priorities may include a first priority, a second priority, and a third priority. The first priority may be to place the user onto an existing application instance of the first application that is already loaded onto a host. The second priority may be to place the user onto a new application instance of the first application and to load the new application instance on a host computing instance of the host computing instance group that has already loaded at least one other application instance and that has sufficient available space for an application size of the first application. The third priority may be to place the user onto the new application instance and to load the new application instance on a host computing instance of the host computing instance group that has not already loaded at least one other application instance. The first priority may be employed when the first priority satisfiable. The second priority may be employed when the second priority is satisfiable and the first priority is not satisfiable. The third priority may be employed when the third priority is satisfiable and when both the first priority and the second priority are not satisfiable.

In some examples, the application streaming service may allow any of the plurality of different applications to be loaded onto any host computing instance in a multi-application host computing instance group at any time that there is sufficient on-host size availability. Thus, in some cases, loading of application instances onto host computing instances may not be performed immediately upon creation of a host computing instance group and may instead be delayed. By delaying loading of application instances onto a host computing instance, the customer may maintain flexibility to allocate application instances to hosts based on relative demand for different applications. This may be particularly advantageous for a multi-application host computing instance group when the relative demand for different applications is not known in advance. By contrast, in some examples, there may be advance notice that a demand for a given application may be strong, such as when a new heavily advertised game is being released. In these examples, a determination may be made to immediately load instances of the in-demand application onto one or more host computing instances in advance even before there is a specific need to do so.

In some examples, the host computing instances in a multi-application host computing instance group may be configured with a file system interface that allows an application to be executed and streamed to users before the application has been fully loaded onto the host computing instance, such as by downloading some application files simultaneously with execution of the application. This may allow applications to be started rapidly even in scenarios when the loading of the application onto the host computing instance is delayed for purposes of maintaining flexibility.

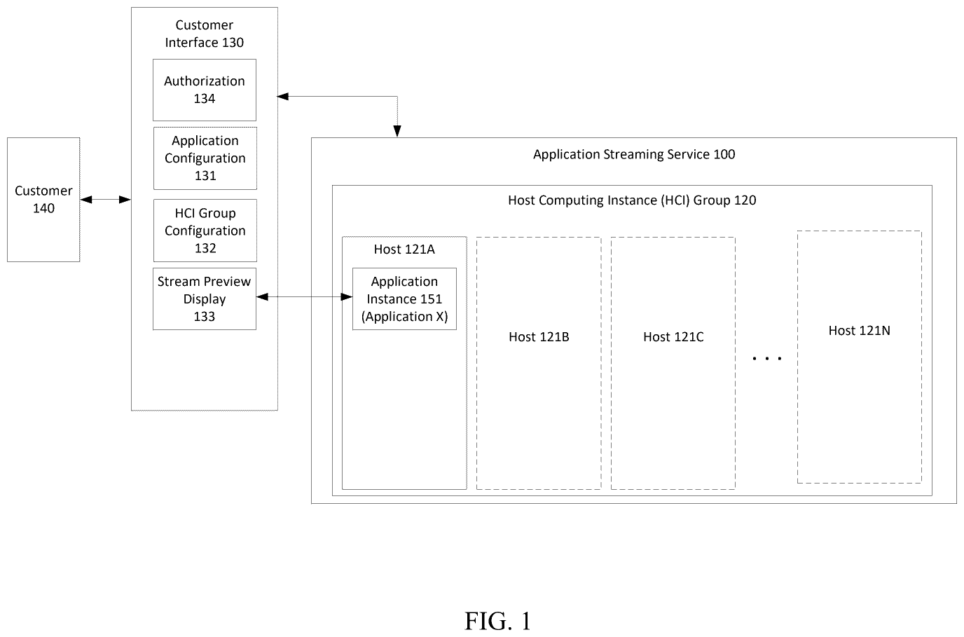

FIG. 1 is a diagram illustrating an example stream preview system for a single application that may be used in accordance with the present description. As shown in FIG. 1, a customer 140 interacts with an application streaming service 100 via a customer interface 130, such as a console interface provided by the application streaming service 100. In the example of FIG. 1, the customer interface 130 may provide features such as application configuration 131, host computing instance (HCI) group configuration 132 and stream preview display 133. To access these features, an authorization 134 may be performed, in which the customer 140 may log-in to the customer interface 130, for example by entering authorized credentials, such as a username and password. In some examples, the customer interface 130 may provide various fields, menus, and other input controls that allow customer 140 to select various values associated with application configuration 131 and host computing instance (HCI) group configuration 132. Specifically, during application configuration 131, the customer 140 may use the customer interface 130 to upload an application (e.g., Application X) to the application streaming service 100, provide appropriate permissions, identify a path to the application files, select a runtime environment on which to run the application, specify an application log path, and perform other associated operations. In some examples, the application streaming service 100 may be a video game streaming service. It is noted that any reference herein to an application may, in some examples, apply to video games or to any other type of application from which output may be captured and streamed.

During HCI group configuration 132, the customer 140 may use the customer interface 130 to configure various features of the HCI group 120. These features may include for example, hardware configuration (e.g., central processing unit (CPU), memory, and graphics processing unit (GPU) selection), linking of one or more applications to the HCI group 120, and selection of a stream capacity for inclusion in the HCI group 120. The stream capacity may be a selected maximum quantity of concurrent streams that may be provided by the HCI group 120 at any given time. In the example of FIG. 1, customer 140 has chosen to link a single application (Application X) to the HCI group 120. HCI group 120 must include at least one host computing instance, which is host 121A of FIG. 1. Depending upon factors such as the selected stream capacity and the requested number of streams at any given time, the HCI group 120 may also optionally include any number of other host computing instances, which are hosts 121B-N (and which are shown in dashed lines to indicate that they optionally may, or may not, be included in HCI group 120). The hosts 121A-N are computing instances, such as virtual machine instances or other computing components capable of hosting execution of an application.

As shown in FIG. 1, customer interface 130 includes a stream preview display 133, which allows the customer 140 to request, view and interact with Application X. In some examples, the customer interface 130 may include a listing of applications that are available for stream preview, which may include any application linked to an active HCI group with available capacity. The customer 140 may then select an application for stream preview, such as Application X. As shown in FIG. 1, in response to a selection of Application X for stream preview, an application instance 151 of Application X may be launched on host 121A. Video captured from application instance 151 of Application X may then be displayed via stream preview display 133. Also, audio captured from application instance 151 of Application X may also be output by customer interface 130 and played via one or more speakers. Additionally, user input (e.g., player control input, etc.) may be collected by customer interface 130 (e.g., via keyboard, joystick, speech input, etc.) and provided as input to application instance 151 of Application X, such as to control player movement, etc.

In some examples, a configurable stream access control tool, such as a Web Real-Time Communication (Web RTC) Interactive Connectivity Establishment (ICE) offer and answer pair, may be used by the application streaming service 100 to control access to streamed applications. For example, an ICE answer may be used in combination with configured access management permissions to ensure that only authorized users can acquire the ICE answer and that only users with the correct ICE answer can connect to a stream. In some examples, an access management permission may be configured that allows the customer interface 130 to request and obtain the ICE answer on behalf of authorized users (e.g., users that successfully log-in to the customer interface 130). Thus, when the customer requests, via the customer interface 130, to interact with a stream preview of Application X, the customer interface 130 may issue an ICE offer. Because of the configured access management permission, the customer interface 130 and then acquire a corresponding ICE answer. The customer interface may then provide the ICE answer to connect to a stream captured from application instance 151, which is an instance of Application X.

Stream preview may allow customer 140 to view and interact with Application X before Application X is made publicly available. This may allow the customer 140 to observe and test how Application X behaves while the being executed by a host 121A of the application streaming service 100, which may be the same execution platform that is eventually used to execute and stream Application X to the public. The customer 140 may therefore detect, and potentially correct, errors, problems or other unwanted features before the Application X is made publicly available. For example, stream preview may allow customer 140 to test and interact with games before the games are made available to the public.

As shown in FIG. 1, the application streaming service 100 may allow the customer 140 to view and interact with an application (e.g., Application X) through the same interface (e.g., customer interface 130) that the customer 140 may use to perform application configuration 131 and HCI group configuration 132. In some examples, the customer interface 130 may also provide metrics for HCI group 120, for example including values such as client-side latency, server response latency, and the like. Additionally, in some examples, the customer 140 may use stream preview to demo an application to their clients and make further modifications to the application based on their clients' feedback before the application is released. For example, in some cases, specialized log-in credentials could be created for customer interface 130 that only allows access to stream preview features. The customer 140 could then provide these specialized log-in credentials to a client of customer 140, such as to allow the client to demo applications via stream preview.

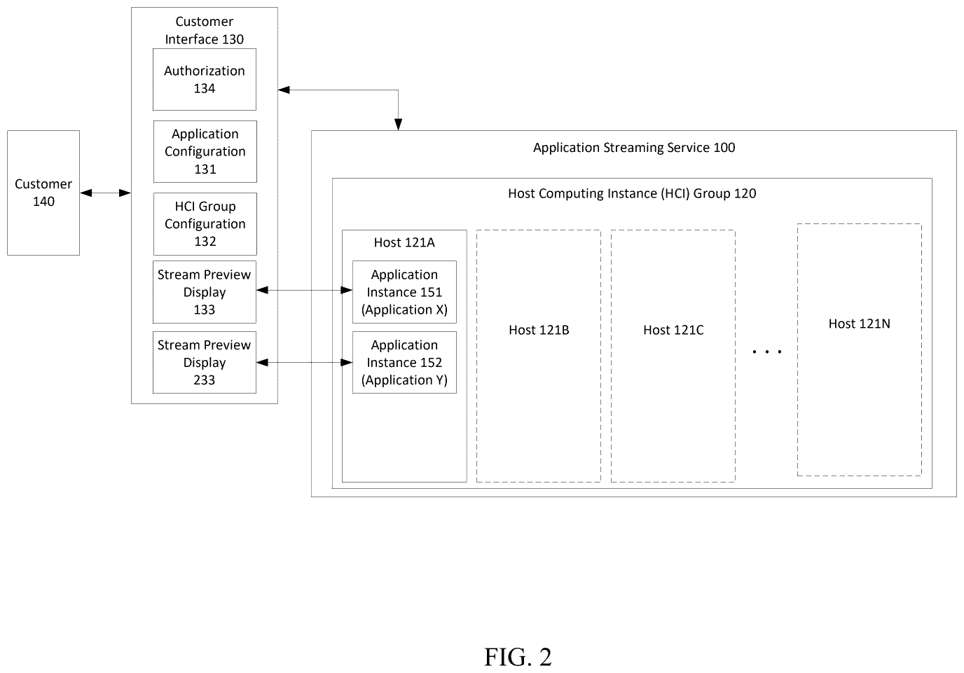

In some examples, multiple different applications may be previewed from a single host computing instance group. Referring now to FIG. 2, an example is shown in which customer 140 may use customer interface 130 to view and interact with a stream captured from Application Y as well as a stream captured from Application X. For example, the customer 140 may request to receive a stream captured form Application Y. In response to this request, application instance 152 of Application Y may be launched on host 121A. Video captured from application instance 152 of Application Y may then be displayed via stream preview display 233, which is an additional feature of customer interface 130. Also, audio captured from application instance 152 of Application Y may also be output by customer interface 130 and played via one or more speakers. Additionally, user input (e.g., player control input, etc.) may be collected by customer interface 130 (e.g., via keyboard, joystick, speech input, etc.) and provided as input to application instance 152 of Application Y, such as to control player movement, etc. In some examples, Application X and Application Y may be different application titles (e.g., a car racing game and a war combat game). In some other examples, Application X and Application Y may be different versions (e.g., development updates/iterations) to a single application title. In one specific example, customer 140 may make updates and changes to Application X, such as based on the customer's interactions with a stream preview of the Application X. The customer may then, for example, create Application Y as an updated version of Application X that incorporates the changes made based on stream preview. Application Y may then be added to an existing host computing instance group (e.g., HCI group 120). The customer 140 may then quickly initiate a stream preview of Application Y, without having to wait for a new host computing instance group to be created. This may reduce the overall time required to test, update and re-test an application prior to publishing a finished version of the application. Thus, by combining stream previewing with multi-application HCI group functionality, the customer 140 may be able to preview, and optionally switch between, multiple application titles and/or application title updates without the need to spend time creating, configuring and managing multiple HCI groups.

As described herein, a multi-application host computing instance group allows a customer 140 to link a plurality of different applications (e.g., Application X and Application Y) to a single host computing instance group (e.g., HCI group 120). For example, a customer may link a plurality of different video game titles to the same host computing instance group. In one specific example, the customer may link a car racing game, a war combat game, and a football game all to the same host computing instance group. This is a contrast with some conventional techniques, in which only a single application could be linked to a single host computing instance group. It is noted that the term different application, as used herein, may refer to both different application titles (e.g., a car racing game and a war combat game) as well different versions of a single application title. Thus, in some examples, a multi-application host computing instance group may include multiple different versions of a single application title.

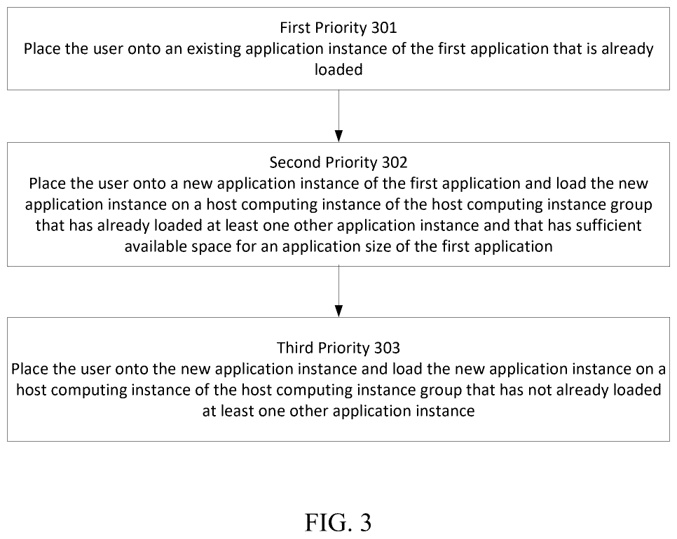

In some examples, a set of user placement priorities may be employed for a multi-application host computing instance group, such as to reduce the amounts of total active applications and active host computing instances that are operated within the multi-application host computing instance group. Reducing the amount of active host computing instances within a host computing instance group may result in a cost savings to the customer. Referring now to FIG. 3, first priority 301, second priority 302 and third priority 303 (referred to collectively as priorities 301-303) are example user placement priorities for a multi-application host computing instance group. In some examples, a request may be received for application instance placement for a user for a first application of a plurality of different applications linked to a host computing instance group. As shown, the first priority 301 is to place the user onto an existing application instance of the first application that is already loaded. The second priority 302 is to place the user onto a new application instance of the first application and to load the new application instance on a host computing instance of the host computing instance group that has already loaded at least one other application instance and that has sufficient available space for an application size of the first application. The third priority 303 is to place the user onto the new application instance and to load the new application instance on a host computing instance of the host computing instance group that has not already loaded at least one other application instance. The first priority 301 may be employed when the first priority 301 satisfiable. The second priority 302 may be employed when the second priority 302 is satisfiable and the first priority 301 is not satisfiable. The third priority 303 may be employed when the third priority 303 is satisfiable and when both the first priority 301 and the second priority 302 are not satisfiable.

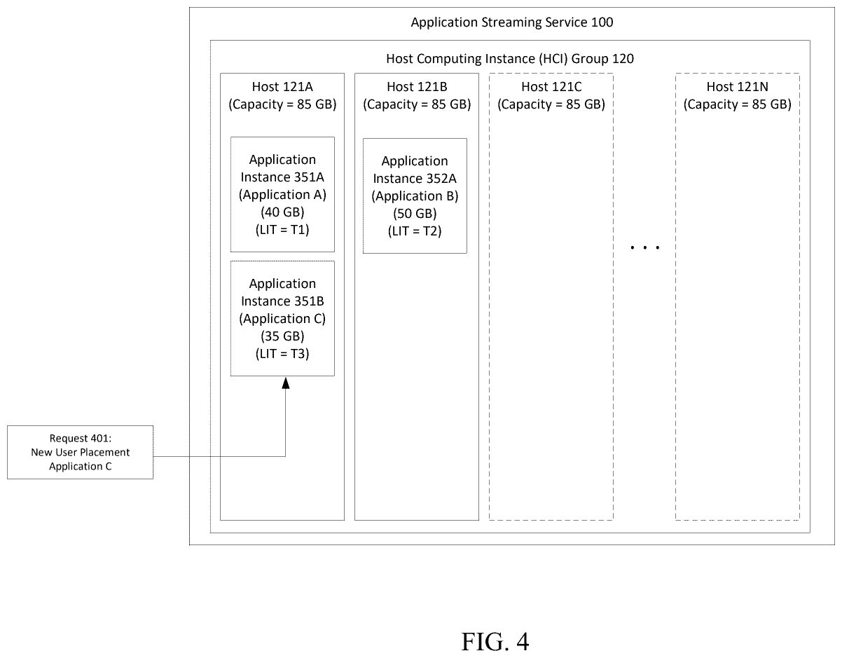

Referring now to FIGS. 4-6, some example user placements will now be described in order to help illustrate the use of priorities 301-303. In the examples of FIGS. 4-6, there are five applications (Applications A-E) that are linked to HCI group 120, which in this example is a multi-application HCI group. In this example, hosts 121A-N each have a capacity of 85 gigabytes (GB) for storage of applications. Also, in this example, Application A has a size of 40 GB, Application B has a size of 50 GB, Application C has a size of 35 GB, Application D has a size of 30 GB, and Application E has a size of 40 GB. As shown in FIG. 4, application instance 351 of Application A is loaded onto host 121A. Additionally, application instance 353 of Application C is also loaded onto host 121A. Furthermore, application instance 352 of Application B is loaded onto host 121B.

In the example of FIG. 4, a request 401 is received to perform a new user placement for Application C. As shown in FIG. 3, the first priority 301 is to place the user onto an existing application instance of the first application (which is Application C for this example) that is already loaded. The first priority 301 may be performed when it is satisfiable. In this example, the first priority 301 is satisfiable because there is at least one existing application instance of Application C that is already loaded onto a host. Specifically, in FIG. 4, application instance 353 of Application C is loaded onto host 121A. Thus, in this example, to satisfy first priority 301, the new user is placed onto application instance 353, as indicated by the arrow from request 401 to application instance 353.

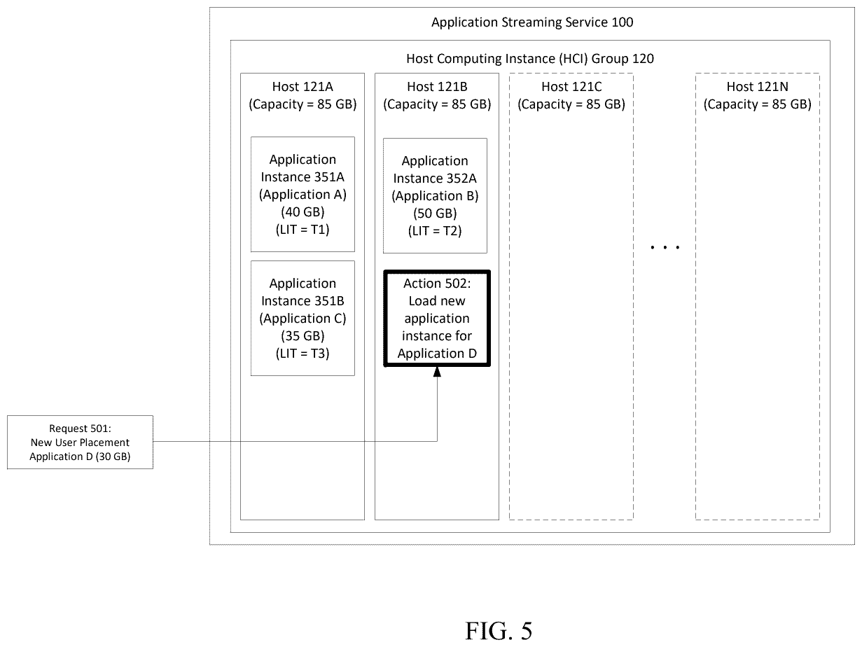

Referring now to FIG. 5, a second example placement scenario will be discussed. FIG. 5 is a similar example as FIG. 4 (described above), with the exception that a request 501 is received, which differs from request 401 of FIG. 4. Specifically, while request 401 was to perform a new user placement for Application C, request 501 is to perform a new user placement for Application D. As shown in FIG. 3, the first priority 301 is to place the user onto an existing application instance of the first application (which is Application D for this example) that is already loaded. The first priority 301 may be performed when it is satisfiable. In the example of FIG. 5, the first priority 301 is not satisfiable because there is no existing application instance of Application D that is already loaded onto a host.

In the example of FIG. 5, when it is determined that first priority 301 cannot be satisfied, an attempt is then made to satisfy second priority 302. As shown in FIG. 3, the second priority 302 is to place the user onto a new application instance of the first application (which is Application D for this example) and to load the new application instance on a host computing instance of the host computing instance group that has already loaded at least one other application instance and that has sufficient available space for an application size of the first application. In the example of FIG. 5, there are two host computing instances (hosts 121A-B) that have already loaded at least one application instance. Specifically, host 121A has loaded application instance 351 of Application A and application instance 353 of Application C. Application A has a size of 40 GB, and Application C has a size of 35 GB. Thus, in this example, host 121A is currently using 75 GB. Because host 121A has an application capacity of 85 GB, this means that host 121A has a remaining capacity of only 10 GB. However, because Application D has a size of 30 GB, Application D will not fit onto host 121A. Thus, host 121A will not satisfy second priority 302. Additionally, host 121B has loaded application instance 352 of Application B, which has a size of 50 GB. Thus, in this example, host 121B is currently using 50 GB. Because host 121B has an application capacity of 85 GB, this means that host 121B has a remaining capacity of 35 GB. Because Application D has a size of 30 GB, Application D will fit onto host 121B. Thus, host 121B will satisfy second priority 302. Accordingly, to satisfy second priority 302, an action 502 is performed, in which a new application instance of Application D is loaded onto host 121B. The new user is placed on the new application instance of Application D, as indicated by the arrow from request 501 to action 502.

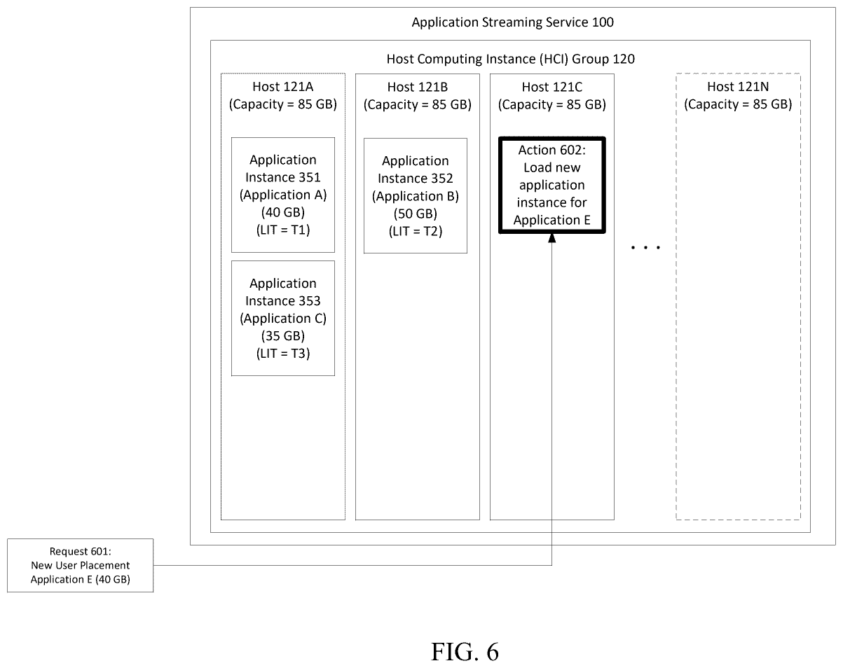

Referring now to FIG. 6, a third example placement scenario will be discussed. FIG. 6 is similar to the examples of FIGS. 4 and 5 (described above), with the exception that a request 601 is received, which differs from request 401 of FIG. 4 and request 501 of FIG. 5. Specifically, request 601 is to perform a new user placement for Application E. As shown in FIG. 3, the first priority 301 is to place the user onto an existing application instance of the first application (which is Application E for this example) that has already been loaded. The first priority 301 may be performed when it is satisfiable. In the example of FIG. 6, the first priority 301 is not satisfiable because there is no existing application instance of Application E that is already loaded.

In the example of FIG. 6, when it is determined that first priority 301 cannot be satisfied, an attempt is then made to satisfy second priority 302. As shown in FIG. 3, the second priority 302 is to place the user onto a new application instance of the first application (which is Application E for this example) and to load the new application instance on a host computing instance of the host computing instance group that has already loaded at least one other application instance and that has sufficient available space for an application size of the first application. In the example of FIG. 6, there are two host computing instances (hosts 121A-B) that have already loaded at least one application instance. Specifically, host 121A is executing application instance 351 of Application A and application instance 353 of Application C. Application A has a size of 40 GB, and Application C has a size of 35 GB. Thus, in this example, host 121A is currently using 75 GB. Because host 121A has an application capacity of 85 GB, this means that host 121A has a remaining capacity of only 10 GB. However, because Application E has a size of 40 GB, Application E will not fit onto host 121A. Thus, host 121A will not satisfy second priority 302. Additionally, host 121B has loaded application instance 352 of Application B, which has a size of 50 GB. Thus, in this example, host 121B is currently using 50 GB. Because host 121B has an application capacity of 85 GB, this means that host 121B has a remaining capacity of 35 GB. Because Application E has a size of 40 GB, Application E will not fit onto host 121B. Thus, host 121B will also not satisfy second priority 302. Thus, there is no host within HCI group 120 that will satisfy the second priority 302.

In the example of FIG. 6, when it is determined that both first priority 301 and second priority 302 cannot be satisfied, an attempt is then made to satisfy the third priority 303. As shown in FIG. 3, the third priority 303 is to place the user onto the new application instance and to load the new application instance on a host computing instance of the host computing instance group that has not already loaded at least one other application instance. The term idle host computing instance, as used herein, refers to a host computing instance that has not already loaded an application instance. In the example of FIG. 6, host computing instances 121C-N are idle. Thus, in the example of FIG. 6, the third priority 303 can be satisfied because there is at least one idle host computing instance in the HCI group 120. Accordingly, in the example of FIG. 6, an action 602 is performed to load a new application instance for Application E onto host 121C. The new user is placed on the new application instance of Application E, as indicated by the arrow from request 601 to action 602.

In the examples of FIGS. 4-6, the term LIT stands for load initiation time, which is the time that loading of an application instance onto a host computing instance is initiated. Specifically, loading of application instance 351 onto host 121A is initiated at time T1, loading of application instance 352 onto host 121B is initiated at time T2, and loading of application instance 353 onto host 121A is initiated at time T3. Time T1 is before time T2, and time T2 is before time T3. For example, application instance 351 may be loaded onto host 121A at time T1 in response to a user request for Application A. Application instance 352 may subsequently be loaded onto host 121B at time T2 in response to a user request for Application B, such as because there may be available space for Application B on host 121B but not host 121A. Application instance 353 may subsequently be loaded onto host 121A at time T3.

In some examples, the application streaming service 100 may allow any of the plurality of different applications to be loaded onto any host computing instance in a multi-application host computing instance group at any time that there is sufficient on-host size availability. Thus, in some cases, loading of application instances onto host computing instances may not be performed immediately upon creation of a host computing instance group and may instead be delayed. By delaying loading of application instances onto a host computing instance, the customer may maintain flexibility to allocate application instances to hosts based on relative demand for different applications. For example, as shown in FIG. 6, prior to receipt of request 601, there are no existing application instances on host 121C. After receipt of request 601, a new instance of Application E is loaded onto host 121C in order to satisfy the demand for Application E. By waiting to load any application instances into host 121C until there is a demand to do so, the application streaming service 100 is able to preserve space on host 121C and fill that space based on user demand. This may be particularly advantageous for a multi-application host computing instance group when the relative demand for different applications is not known in advance. By contrast, in some examples, there may be advance notice that a demand for a given application may be strong, such as when a new heavily advertised game is being released. In these examples, a determination may be made to immediately load instances of the in-demand application onto one or more host computing instances in advance even before there is a specific need to do so.

In some examples, the host computing instances in a multi-application host computing instance group may be configured with a file system interface that allows an application to be executed and streamed to users before the application has been fully loaded onto the host computing instance, such as by downloading some application files simultaneously with execution of the application. This may allow applications to be started rapidly even in scenarios when the loading of the application onto the host computing instance is delayed for purposes of maintaining flexibility. For example, with respect to FIG. 6, a rapid start file system interface on host 121C may allow the user to begin streaming and interacting with the new application instance of Application E before the new application instance has been fully downloaded to host 121C. This may be accomplished by having the rapid start file system interface download a listing of application files for Application E and present the listing of application files to the new instance of Application E that executes on host 121C. The application instance may then request files from this file listing, even when the files have not yet been downloaded to host 121C. When the application instance requests files that have already been downloaded to host 121C, the file system interface may obtain those files from local storage and provide the requested files to the application instance. By contrast, when the application instance requests files that have not yet been downloaded to host 121C, the file system interface may prioritize the downloading of those files. The file system interface may then provide the files to the application instance when they are downloaded and also store the files in the local storage.

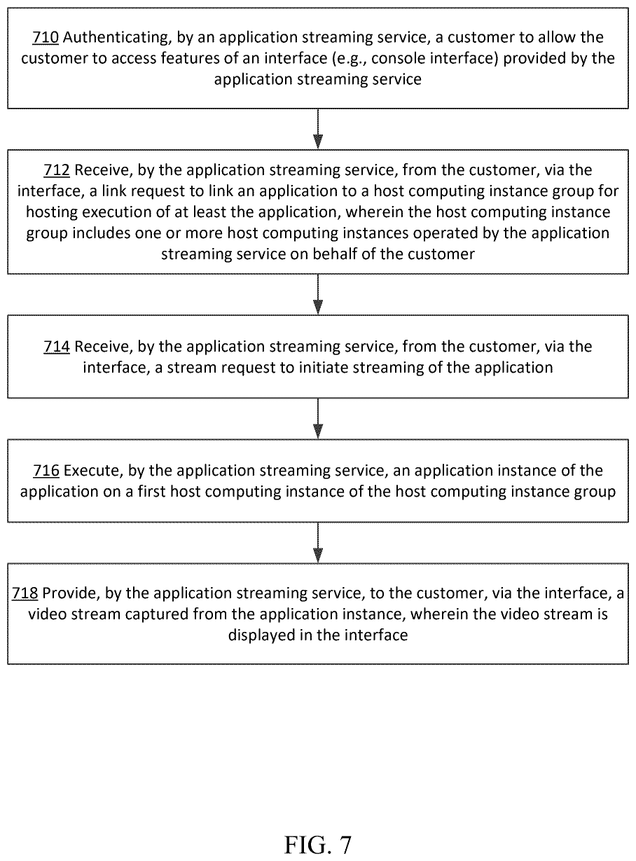

FIG. 7 is a flowchart illustrating an example stream previewing process that may be used in accordance with the present description. At operation 710, the application streaming service authenticates a customer to allow the customer to access features of an interface provided by the application streaming service. In some examples, the interface may be a console interface. As described above with reference example of FIG. 1, a customer 140 interacts with an application streaming service 100 via a customer interface 130, such as a console interface provided by the application streaming service 100. In the example of FIG. 1, the customer interface 130 may provide features such as application configuration 131, host computing instance (HCI) group configuration 132 and stream preview display 133. To access these features, an authorization 134 may be performed, in which the customer 140 may log-in to the customer interface 130, for example by entering authorized credentials, such as a username and password.

At operation 712, the application streaming service receives, from the customer, via the interface, a link request to link an application to a host computing instance group for hosting execution of at least the application, wherein the host computing instance group includes one or more host computing instances operated by the application streaming service on behalf of the customer. As described above, during HCI group configuration 132, the customer 140 may use the customer interface 130 to configure various features of the HCI group 120. These features may include for example, hardware configuration (e.g., central processing unit (CPU), memory, and graphics processing unit (GPU) selection), linking of one or more applications to the HCI group 120, and selection of a stream capacity for inclusion in the HCI group 120. The stream capacity may be a selected maximum quantity of concurrent streams that may be provided by the HCI group 120 at any given time. In some examples, the application may be a video game or another type of application from which video may be captured, such as a flight simulator or other simulator. In one specific example, the customer interface 130 may provide a list of applications that have been uploaded by the customer 140 to the application streaming service 100, and the customer 140 may select the application from the list for linking to the host computing instance group. In another specific example, the application streaming service 100 may maintain a record of applications that have been uploaded by the customer 140 to the application streaming service 100, and the customer interface 130 may allow the customer 140 to search for the application (e.g., by name) and select the application for linking to the host computing instance group. Linking an application to a host computing instance group refers to associating an application with a host computing instance group to allow one or more application instances of the application to be loaded onto, and executed by, one or more host computing instances in the host computing instance group. Thus, to allow a host computing instance in a given host computing group to load and execute a given application from which video is captured and streamed to a user, a customer may first request that the given application be linked to the given host computing instance group. In some examples, the application streaming service 100 may store a record indicating an association between a given host computing instance group and one or more given applications that are linked to the given host computing instance group.

At operation 714, the application streaming service receives, from the customer, via the interface, a stream request to initiate streaming of the application. As described above, in some examples, the customer interface 130 may include listing of applications that are available for stream preview, which may include any application linked to an active HCI group with available capacity. The customer 140 may then select an application for stream preview, such as Application X.

At operation 716, the application streaming service executes an application instance of the application on a first host computing instance of the host computing instance group. As shown in FIG. 1, in response to a selection of Application X for stream preview, an application instance 151 of Application X may be launched on host 121A. At operation 718, the application streaming service provides, to the customer, via the interface, a video stream captured from the application instance, wherein the video stream is displayed in the interface. As described above, video captured from application instance 151 of Application X may be displayed via stream preview display 133. Additionally, the interface may allow the customer to interact with the first video stream. For example, user input (e.g., player control input, etc.) may be collected by customer interface 130 (e.g., via keyboard, joystick, speech input, etc.) and transmitted, and provided as input, to application instance 151 of Application X, such as to control player movement, etc. In some examples, the application streaming service may provide, to the customer, via the interface, an audio stream captured from the first application instance. The audio stream may be output by the interface and played via one or more speakers. As described above, in some examples, a configurable stream access control tool, such as a Web RTC Interactive Connectivity Establishment (ICE) offer and answer pair, may be used by the application streaming service 100 to control access to streamed applications. For example, an ICE answer may be used in combination with configured access management permissions to ensure that only authorized users can acquire the ICE answer and that only users with the correct ICE answer can connect to a stream. In some examples, an access management permission may be configured that allows the customer interface 130 to request and obtain the ICE answer on behalf of authorized users (e.g., users that successfully log-in to the customer interface 130).

In some examples, the video stream may allow the customer to preview streaming of the application using resources of the application streaming service before the customer makes the application publicly available. As described above, stream preview may allow customer 140 to view and interact with Application X before Application X is made publicly available. This may allow the customer 140 to observe and test how Application X behaves while the being executed by a host 121A of the application streaming service 100, which may be the same execution platform that is eventually used to execute and stream Application X to the public. The customer 140 may therefore detect, and potentially correct, errors, problems or other unwanted features before the Application X is made publicly available. For example, stream preview may allow customer 140 to test and interact with games before the games are made available to the public.

In some examples, if the customer 140 is satisfied with Application X, the customer may make Application X available to the public, for example for a fee. In these examples, the same host computing instance group (e.g., HCI group 120) that was used to preview Application X may also be used to stream Application X to users. These users may pay a fee to the customer and may be authenticated by an authentication service operating on behalf of the customer. Thus, in some examples, the application streaming service may provide, to users that are authenticated by an authentication service operating on behalf of the customer, additional video streams corresponding to additional application instances of the application executing on additional host computing instances of the host computing instance group.

In some examples, multiple different applications may be previewed from a single host computing instance group. Thus, in some examples, the application described with reference to operations 710-718 may be a first application, and a first application instance of the first application may be executed on a first host computing instance of the host computing instance group. The application streaming service may receive, from the customer, via the interface, a second link request to link a second application to the host computing instance group. The application streaming service may receive, from the customer, via the interface, a second stream request to initiate streaming of the second application. The application streaming service may execute a second application instance of the second application on the first host computing instance or another host computing instance of the host computing instance group. The application streaming service may provide, to the customer, via the interface, a second video stream captured from the second application instance, wherein the second video stream is displayed in the interface. For example, as described above with reference to FIG. 2, customer 140 may use customer interface 130 to request to view and interact with a stream captured from Application Y. In response to this request, application instance 152 of Application Y may be launched on host 121A. Video and audio captured from application instance 152 of Application Y may then be displayed via stream preview display 233. Additionally, user input (e.g., player control input, etc.) may be collected by customer interface 130 (e.g., via keyboard, joystick, speech input, etc.) and provided as input to application instance 152 of Application Y, such as to control player movement, etc.

In some examples, the second application may be a different application title than the first application. For example, Application X and Application Y may be different application titles (e.g., a car racing game and a war combat game). In some other examples, the second application and the first application may be a same application title, wherein the second application is an updated version of the first application. For example, Application X and Application Y may be different versions (e.g., development updates/iterations) to a single application title. In one specific example, customer 140 may make updates and changes to Application X, such as based on the customer's interactions with a stream preview of Application X. The customer may then, for example, create Application Y as an updated version of Application X that incorporates the changes made based on stream preview. Thus, by combining stream previewing with multi-application HCI group functionality, the customer 140 may be able to preview, and optionally switch between, multiple application titles and/or application title updates without the need to spend time creating, configuring, and managing multiple HCI groups.

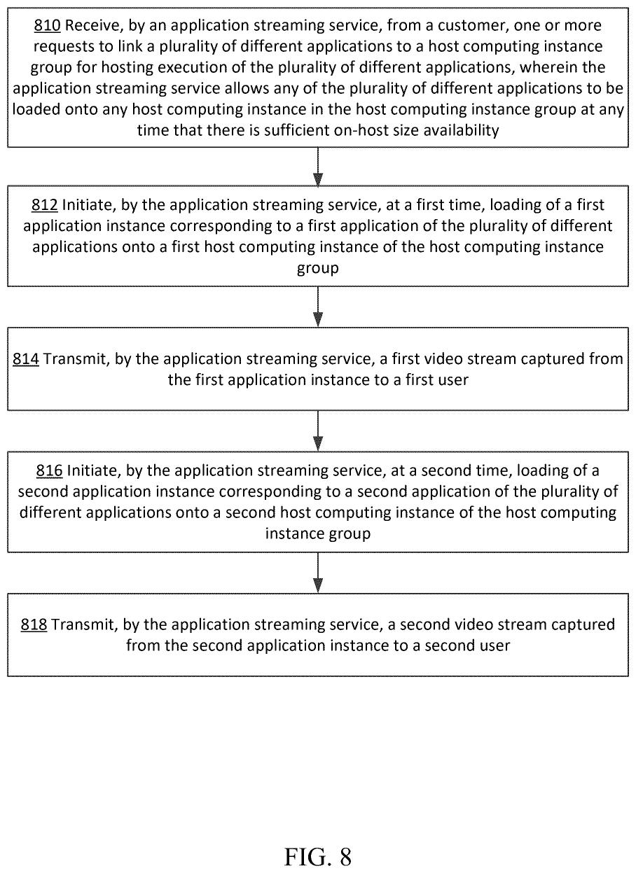

FIG. 8 is a flowchart illustrating an example application streaming process for a multi-application host computing instance group that may be used in accordance with the present description. At operation 810, an application streaming service receives, from a customer, one or more requests to link a plurality of different applications to a host computing instance group for hosting execution of the plurality of different applications, wherein the application streaming service allows any of the plurality of different applications to be loaded onto any host computing instance in the host computing instance group at any time that there is sufficient on-host size availability. As described above, above, during HCI group configuration 132, the customer 140 may use the customer interface 130 to configure various features of the HCI group 120. These features may include for example, hardware configuration (e.g., central processing unit (CPU), memory, and graphics processing unit (GPU) selection), linking of one or more applications to the HCI group 120, and selection of a stream capacity for inclusion in the HCI group 120. In one specific example, the customer interface 130 may provide a list of applications that have been uploaded by the customer 140 to the application streaming service 100, and the customer 140 may select the applications from the list for linking to the host computing instance group. In another specific example, the application streaming service 100 may maintain a record of applications that have been uploaded by the customer 140 to the application streaming service 100, and the customer interface 130 may allow the customer 140 to search for the applications (e.g., by name) and select the applications for linking to the host computing instance group.

As also described above, the application streaming service may allow any of the plurality of different applications to be loaded onto any host computing instance in the host computing instance group at any time that there is sufficient on-host size availability. Thus, in some cases, loading of application instances onto host computing instances may not be performed immediately upon creation of a host computing instance group and may instead be delayed. By delaying loading of application instances onto a host computing instance, the customer may maintain flexibility to allocate application instances to hosts based on relative demand for different applications. For example, as shown in FIG. 6, prior to receipt of request 601, there are no existing application instances on host 121C. After receipt of request 601, a new instance of Application E is loaded onto host 121C in order to satisfy the demand for Application E. By waiting to load any application instances into host 121C until there is a demand to do so, the application streaming service 100 is able to preserve space on host 121C and fill that space based on user demand. This may be particularly advantageous when the relative demand for different applications is not known in advance. By contrast, in some examples, there may be advance notice that a demand for a given application may be strong, such as when a new heavily advertised game is being released. In these examples, a determination may be made to immediately load instances of the in-demand application onto one or more host computing instances in advance even before there is a specific need to do so. In some examples, the host computing instances in a multi-application host computing instance group may be configured with a file system interface that allows an application to be executed and streamed to users before the application has been fully loaded onto the host computing instance, such as by downloading some application files simultaneously with execution of the application. This may allow applications to be started rapidly even in scenarios when the loading of the application onto the host computing instance is delayed for purposes of maintaining flexibility.

At operation 812, the application streaming service initiates, at a first time, loading of a first application instance corresponding to a first application of the plurality of different applications onto a first host computing instance of the host computing instance group. For example, as described above with reference to FIGS. 4-6, application instance 351 of Application A may be loaded onto host 121A at time T1. This is indicated in FIGS. 4-6 by the expression LIT=T1 being shown inside application instance 351, with LIT being an abbreviation for load initiation time, which is the time that loading of an application instance onto a host computing instance is initiated. In some examples, application instance 351 may be loaded onto host 121A based on a user request to join Application A. In some examples, the loading of the first application instance onto the first host computing instance may be initiated before an initiation of loading of any other application instances corresponding to any of the plurality of different applications onto the first host computing instance. In the examples of FIG. 4-6, initiation of loading of application instance 351 is at time T1, which is before the initiation of loading of any other application instance onto host 121A. In some examples, the first application may be a video game or another type of application from which video may be captured, such as a flight simulator or other simulator.

Also, in some examples, the loading of the first application instance onto the first host computing instance may be performed based on priorities 301-303. In some examples, the first application instance may be loaded onto the first host computing instance based at least in part on a determination that no application instance of the first application has been loaded onto any host computing instance in the host computing instance group (e.g., a determination that the first priority 301 is not satisfiable). As described above, if there is no application instance of the first application has been loaded onto any host computing instance in the host computing instance group, then an attempt may be made to load the first application instance onto a host that has already loaded at least one other application instance (e.g., to satisfy second priority 302). If the second priority 302 is not satisfiable, then an attempt may be made to load the first application instance onto an idle host that has not already loaded at least one other application instance (e.g., to satisfy third priority 303). The loading of the first application instance onto the first host computing instance may be completed, such as when the application files for the first application are fully loaded onto the first host computing instance. As described above, in some examples, execution and streaming of the first application instance may begin before the first application instance is fully loaded onto the first host computing instance.

At operation 814, the application streaming service transmits a first video stream captured from the first application instance to a first user. Specifically, the application streaming service may transmit the first video stream over one or more networks (e.g., including the Internet) to a computing device operated by the first user, for example using any of a variety of known video transmission protocols and/or streaming video transmission specifications. In some examples, the first video stream may be captured from the first application instance using any of a variety of known video capture tools. The application streaming service may also transmit any number of additional video streams captured from the first application instance to any number of additional users. Furthermore, the application streaming service may also transmit one or more audio streams captured from the first application instance to the first user and any number of additional users. The first user may interact with the first application instance, such as by providing user control input (e.g., character control input in a video game) that is received and provided as input to the first application instance.

At operation 816, the application streaming service initiates, at a second time, loading of a second application instance corresponding to a second application of the plurality of different applications onto a second host computing instance of the host computing instance group. For example, as described above with reference to FIGS. 4-6, application instance 352 of Application B may be loaded onto host 121B at time T2. This is indicated in FIGS. 4-6 by the expression LIT=T2 being shown inside application instance 352. In some examples, application instance 352 may be loaded onto host 121B based on a user request to join Application B. In some cases, the loading of the second application instance onto the second host computing instance may be initiated before an initiation of loading of any other application instances corresponding to any of the plurality of different applications onto the second host computing instance. In the examples of FIG. 4-6, initiation of loading of application instance 352 is at time T2, which is before the initiation of loading of any other application instance onto host 121B. Also, in some examples, the loading of the second application instance onto the second host computing instance may be performed based on priorities 301-303. In some examples, the first application and the second application may have different respective application sizes. In some examples, the first application and the second application may be different application titles. In some other examples, the first application and the second application may be the same application title, for example with the second application being an updated version of the first application. The loading of the second application instance onto the second host computing instance may be completed, such as when the application files for the second application are fully loaded onto the second host computing instance. As described above, in some examples, execution and streaming of the second application instance may begin before the second application instance is fully loaded onto the second host computing instance.

At operation 818, the application streaming service transmits a second video stream captured from the second application instance to a second user. Specifically, the application streaming service may transmit the second video stream over one or more networks (e.g., including the Internet) to a computing device operated by the second user, for example using any of a variety of known video transmission protocols and/or streaming video transmission specifications. In some examples, the second video stream may be captured from the second application instance using any of a variety of known video capture tools. The application streaming service may also transmit any number of additional video streams captured from the second application instance to any number of additional users. Furthermore, the application streaming service may also transmit one or more audio streams captured from the second application instance to the second user and any number of additional users. The second user may interact with the second application instance, such as by providing user control input (e.g., character control input in a video game) that is received and provided as input to the second application instance.

In some examples, loading of a third application instance of a third application onto the first host computing instance may be initiated at a third time. For example, as described above with reference to FIGS. 4-6, application instance 353 of Application C may be loaded onto host 121A at time T3. This is indicated in FIGS. 4-6 by the expression LIT=T3 being shown inside application instance 353. In some examples, application instance 353 may be loaded onto host 121B based on a user request to join Application C. Also, in some examples, the loading of the third application instance onto the third host computing instance may be performed based on priorities 301-303.

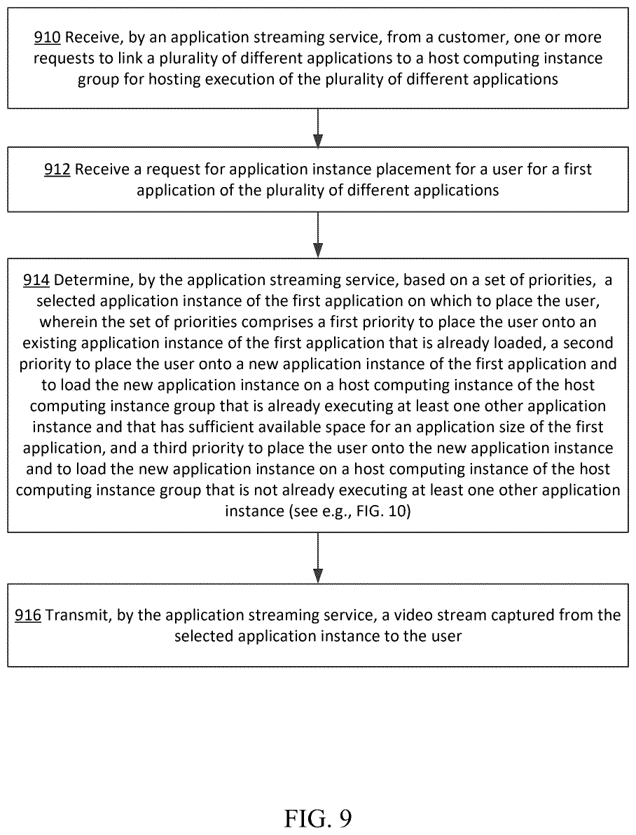

FIG. 9 is a flowchart illustrating an example user placement process for a multi-application host computing instance group that may be used in accordance with the present description. At operation 910, an application streaming service receives, from a customer, one or more requests to link a plurality of different applications to a host computing instance group for hosting execution of the plurality of different applications. As described above, above, during HCI group configuration 132, the customer 140 may use the customer interface 130 to configure various features of the HCI group 120. These features may include for example, hardware configuration (e.g., central processing unit (CPU), memory, and graphics processing unit (GPU) selection), linking of one or more applications to the HCI group 120, and selection of a stream capacity for inclusion in the HCI group 120. In one specific example, the customer interface 130 may provide a list of applications that have been uploaded by the customer 140 to the application streaming service 100, and the customer 140 may select the applications from the list for linking to the host computing instance group. In another specific example, the application streaming service 100 may maintain a record of applications that have been uploaded by the customer 140 to the application streaming service 100, and the customer interface 130 may allow the customer 140 to search for the applications (e.g., by name) and select the applications for linking to the host computing instance group. In some examples, the first application may be a video game or another type of application from which video may be captured, such as a flight simulator or other simulator. In some examples, at least two (and in some cases all) of the plurality of different applications may be different application titles. Also, in some examples, at least two (and in some cases all) of the plurality of different applications may be different versions of the same application title, for example with a second application being an updated version of the first application.

At operation 912, a request for application instance placement is received for a user for a first application of the plurality of different applications. For example, operation 912 may be performed when a user (e.g., a video game player) requests to join the first application (e.g., requests to play a given video game). As described above, customer 140 is a customer of the application streaming service 100. In some examples, customer 140 may be a video game developer or other application developer. Also, in some examples, the user that requests to join the first application may be a customer of customer 140. For example, the user may pay a fee to the customer 140 in order to play a game or other application developed by customer 140. In some examples, when the user requests to join the first application, the user may be authenticated by an authentication service that authenticates the user on behalf of customer 140. In some examples, after the user has been successfully authenticated, the application streaming service 100 may receive a request to place the user onto an application instance of the first application.

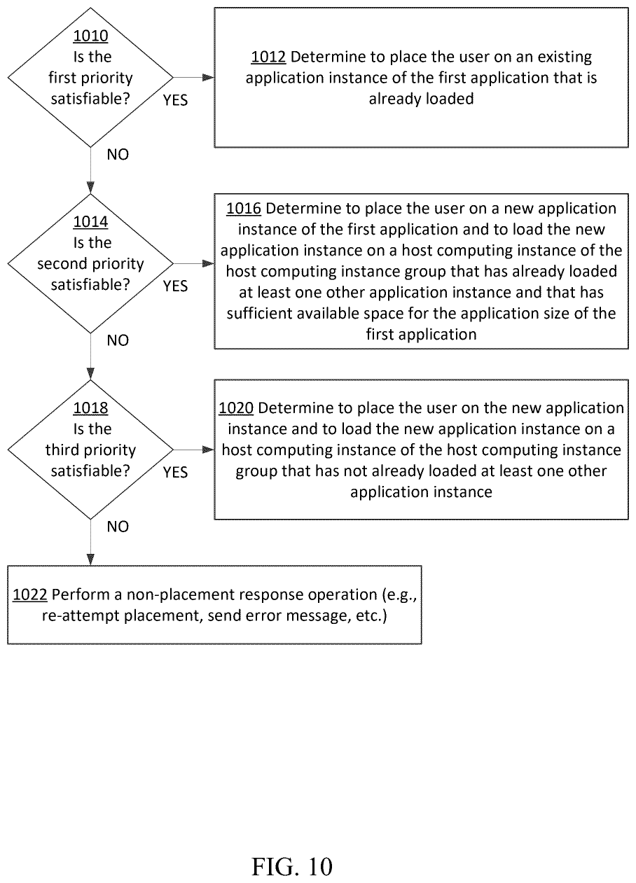

At operation 914, the application streaming service determines, based on a set of priorities, a selected application instance of the first application on which to place the user, wherein the set of priorities comprises a first priority to place the user onto an existing application instance of the first application that is already loaded, a second priority to place the user onto a new application instance of the first application and to load the new application instance on a host computing instance of the host computing instance group that has already loaded at least one other application instance and that has sufficient available space for an application size of the first application, and a third priority to place the user onto the new application instance and to load the new application instance on a host computing instance of the host computing instance group that has not already loaded at least one other application instance. As described above, in some examples, the first priority is employed when the first priority satisfiable, the second priority is employed when the second priority is satisfiable and the first priority is not satisfiable, and the third priority is employed when the third priority is satisfiable and when both the first priority and the second priority are not satisfiable. Some example techniques for determining the selected application instance on which to place the user are described in greater detail below with reference to FIG. 10.

At operation 916, the application streaming service transmits a video stream captured from the selected application instance to the user. Specifically, the application streaming service may transmit the video stream over one or more networks (e.g., including the Internet) to a computing device operated by the user, for example using any of a variety of known video transmission protocols and/or streaming video transmission specifications. In some examples, the first video stream may be captured from the selected application instance using any of a variety of known video capture tools. The application streaming service may also transmit any number of additional video streams captured from the selected application instance to any number of additional users. Furthermore, the application streaming service may also transmit one or more audio streams captured from the selected application instance to the user and any number of additional users. The user may interact with the selected application instance, such as by providing user control input (e.g., character control input in a video game) that is received and provided as input to the selected application instance.

FIG. 10 is a flowchart illustrating an example application instance selection process for user placement for a multi-application host computing instance group that may be used in accordance with the present description. FIG. 10 shows an example process that may be performed as at least part of operation 914 of FIG. 9. Specifically, FIG. 10 shows an example process that may be employed to determine the selected application instance on which to place the user at operation 914 of FIG. 9. In particular, at operation 1010, it is determined whether the first priority is satisfiable. As shown in FIG. 3, the first priority 301 is to place the user onto an existing application instance of the first application that is already loaded. An existing application instance, as that term is used herein, refers to an application instance that has already been loaded onto a host computing instance. Thus, in order to perform operation 1010, the application streaming service 100 may determine if there is an application instance of the first application that has been already loaded onto any of the host computing instances within the host computing instance group.

If the first priority is satisfiable, then the process proceeds to operation 1012. At operation 1012, a determination is made to place the user onto an existing application instance of the first application that is already loaded. FIG. 4, shows an example in which a request 401 is received to place the user onto Application C. In the example of FIG. 4, the first priority 301 is satisfiable because there is at least one existing application instance of Application C that is already loaded. Specifically, in FIG. 4, application instance 353 of Application C is already loaded onto host 121A. Thus, in this example, to satisfy first priority 301, the user is placed onto application instance 353, as indicated by the arrow from request 401 to application instance 353.

If the first priority is not satisfiable, then the process proceeds to operation 1014. Thus, operation 1014 may be performed based on determining that the first priority is not satisfiable. At operation 1014, it is determined whether the second priority is satisfiable. As shown in FIG. 3, the second priority 302 is to place the user onto a new application instance of the first application and to load the new application instance on a host computing instance of the host computing instance group that has already loaded at least one other application instance and that has sufficient available space for an application size of the first application. Thus, in order to perform operation 1014, the application streaming service 100 may determine an available remaining space capacity for each non-idle host computing instance in the host computing instance group to which the first application is linked. The application streaming service may then compare the remaining space capacity for each non-idle host computing instance to the application size of the first application to determine whether any non-idle computing instance has sufficient available space for the application size of the first application. In some examples, each non-idle host computing instance may be configured to periodically report a current amount of available space capacity. Also, in some examples, one or more components of the application streaming service 100 may use this information to update and maintain a mapping that indicates an amount of available space capacity for each non-idle host computing instance.

If the second priority is satisfiable, then the process proceeds to operation 1016. At operation 1016, a determination is made to place the user on a new application instance of the first application and to load the new application instance on a host computing instance of the host computing instance group that has already loaded at least one other application instance and that has sufficient available space for the application size of the first application. FIG. 5, shows an example in which a request 501 is received to place the user onto Application D. In the example of FIG. 5, the first priority 301 is not satisfiable because there is no existing application instance of Application D that is already loaded. When it is determined that first priority 301 cannot be satisfied, an attempt is then made to satisfy second priority 302. In the example of FIG. 5, there are two host computing instances (hosts 121A-B) that are already executing at least one application instance. Specifically, host 121A is executing application instance 351 of Application A and application instance 353 of Application C. Application A has a size of 40 GB, and Application C has a size of 35 GB. Thus, in this example, host 121A is currently using 75 GB. Because host 121A has an application capacity of 85 GB, this means that host 121A has a remaining capacity of only 10 GB. However, because Application D has a size of 30 GB, Application D will not fit onto host 121A. Thus, host 121A will not satisfy second priority 302. Additionally, host 121B is executing application instance 352 of Application B, which has a size of 50 GB. Thus, in this example, host 121B is currently using 50 GB. Because host 121B has an application capacity of 85 GB, this means that host 121B has a remaining capacity of 35 GB. Because Application D has a size of 30 GB, Application D will fit onto host 121B. Thus, host 121B will satisfy second priority 302. Accordingly, to satisfy second priority 302, an action 502 is performed, in which a new application instance of Application D is loaded onto host 121B. The new user is placed on the new application instance of Application D, as indicated by the arrow from request 501 to action 502.

If the second priority is not satisfiable, then the process proceeds to operation 1018. Thus, operation 1018 may be performed based on determining that the second priority is not satisfiable. At operation 1018, it is determined whether the third priority is satisfiable. As shown in FIG. 3, the third priority 303 is to place the user onto the new application instance and to load the new application instance on a host computing instance of the host computing instance group that has not already loaded at least one other application instance. Thus, in order to perform operation 1018, the application streaming service 100 may determine if there are any remaining idle hosts associated with the host computing instance group to which the first application instance is linked. In some examples, the customer 140 may select a configurable maximum number of hosts that may be included in the host computing instance group. If the host computing instance already includes the maximum number of hosts and they are all non-idle (and/or if no additional idle hosts are available to be added to the host computing instance group), then the third priority may not be satisfiable. Also, in some examples, the application streaming service 100 may maintain a record that indicates an activity status for each host computing instance in the host computing instance group. The activity status may indicate whether each corresponding host computing instance is non-idle (meaning that it has loaded at least one application instance) or idle (meaning that it has not loaded at least one application instance). In some examples, the application streaming service 100 may use this record to determine if there is at least one remaining idle host associated with the host computing instance group to which the first application instance is linked. If there is at least one remaining idle host, then the third priority may be satisfiable. If there is not at least one remaining idle host (and/or if no additional idle hosts are available to be added to the host computing instance group), then the third priority may not be satisfiable.

If the third priority is satisfiable, then the process proceeds to operation 1020. At operation 1020, a determination is made to place the user onto the new application instance and to load the new application instance on a host computing instance of the host computing instance group that has not already loaded at least one other application instance. FIG. 6, shows an example in which a request 601 is received to place the user onto Application E. In the example of FIG. 6, the first priority 301 is not satisfiable because there is no existing application instance of Application E that is already loaded. Additionally, the second priority is not satisfiable because there is no host computing instance of the host computing instance group that has already loaded at least one application instance and that has sufficient available space for the application size of Application E. Thus, after it is determined that both first priority 301 and second priority 302 cannot be satisfied, it is then determined whether the third priority 303 can be satisfied. In the example of FIG. 6, host computing instances 121C-N are idle. Thus, in the example of FIG. 6, the third priority 303 can be satisfied because there is at least one idle host computing instance in the HCI group 120. Accordingly, in the example of FIG. 6, an action 602 is performed to load a new application instance for Application E onto host 121C. The new user is placed on the new application instance of Application E, as indicated by the arrow from request 601 to action 602.

If the third priority is not satisfiable, then the process proceeds to operation 1022. Thus, operation 1022 may be performed based on determining that the third priority is not satisfiable. At operation 1022, a non-placement response operation is performed. A non-placement response operation is any operation is any operation that is performed in response to an inability to satisfy any of the user placement priorities (e.g., priorities 301-303 of FIG. 3). In some examples, the non-placement response operation may include re-attempting placement of the user, sending an error message to the user and/or customer 140, or another operation. In some examples, the re-attempting placement of the user may include waiting for a configurable time period and then repeating the process of FIG. 10. Also, in some examples, the sending an error message to the user and/or customer 140 may indicate that user placement is not currently possible but may be re-attempted after a configurable time period.

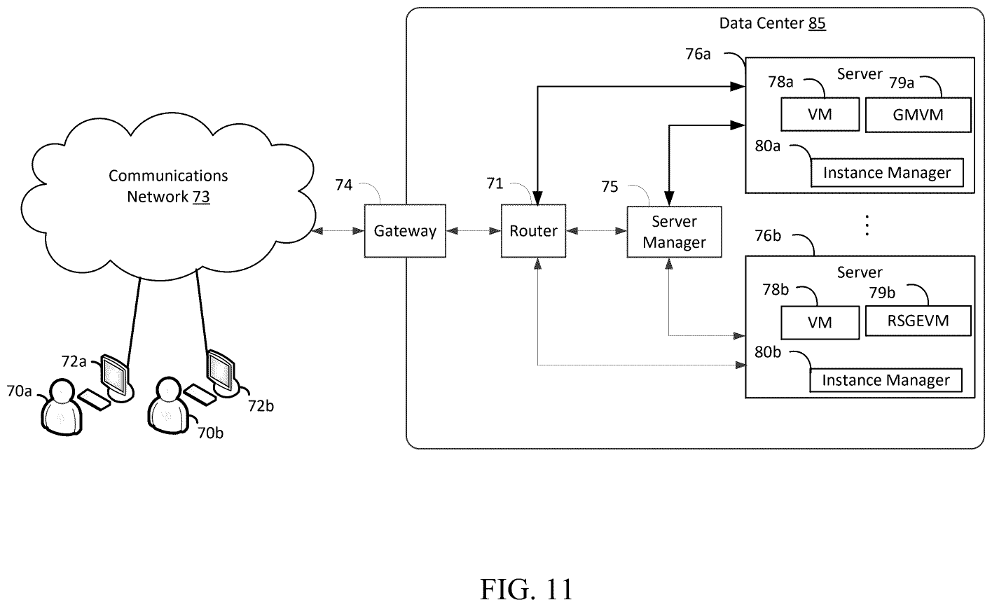

An example system for transmitting and providing data will now be described in detail. In particular, FIG. 11 illustrates an example computing environment in which the embodiments described herein may be implemented. FIG. 11 is a diagram schematically illustrating an example of a data center 85 that can provide computing resources to users 70a and 70b (which may be referred herein singularly as user 70 or in the plural as users 70) via user computers 72a and 72b (which may be referred herein singularly as computer 72 or in the plural as computers 72) via a communications network 73. Data center 85 may be configured to provide computing resources for executing applications on a permanent or an as-needed basis. The computing resources provided by data center 85 may include various types of resources, such as gateway resources, load balancing resources, routing resources, networking resources, computing resources, volatile and non-volatile memory resources, content delivery resources, data processing resources, data storage resources, data communication resources and the like. Each type of computing resource may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services and the like. These services may be configurable with set or custom applications and may be configurable in size, execution, cost, latency, type, duration, accessibility and in any other dimension. These web services may be configured as available infrastructure for one or more clients and can include one or more applications configured as a platform or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols, such as transmission control protocol (TCP), and less reliable transport layer protocols, such as user datagram protocol (UDP). Data storage resources may include file storage devices, block storage devices and the like.

Each type or configuration of computing resource may be available in different sizes, such as large resources—consisting of many processors, large amounts of memory and/or large storage capacity—and small resources—consisting of fewer processors, smaller amounts of memory and/or smaller storage capacity. Customers may choose to allocate a number of small processing resources as web servers and/or one large processing resource as a database server, for example.

Data center 85 may include servers 76a and 76b (which may be referred herein singularly as server 76 or in the plural as servers 76) that provide computing resources. These resources may be available as bare metal resources or as virtual machine instances 78a-b (which may be referred herein singularly as virtual machine instance 78 or in the plural as virtual machine instances 78). In this example, the resources also include group management virtual machines (GMVM's) 79a-b, which are virtual machines that are configured to execute any, or all, of the HCI group related techniques described above, for example including implementation of stream preview and/or multi-application HCI group features.

The availability of virtualization technologies for computing hardware has afforded benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that span multiple distinct physical computing systems.

Referring to FIG. 11, communications network 73 may, for example, be a publicly accessible network of linked networks and possibly operated by various distinct parties, such as the Internet. In other embodiments, communications network 73 may be a private network, such as a corporate or university network that is wholly or partially inaccessible to non-privileged users. In still other embodiments, communications network 73 may include one or more private networks with access to and/or from the Internet.

Communication network 73 may provide access to computers 72. User computers 72 may be computers utilized by users 70 or other customers of data center 85. For instance, user computer 72a or 72b may be a server, a desktop or laptop personal computer, a tablet computer, a wireless telephone, a personal digital assistant (PDA), an e-book reader, a game console, a set-top box or any other computing device capable of accessing data center 85. User computer 72a or 72b may connect directly to the Internet (e.g., via a cable modem or a Digital Subscriber Line (DSL)). Although only two user computers 72a and 72b are depicted, it should be appreciated that there may be multiple user computers.

User computers 72 may also be utilized to configure aspects of the computing resources provided by data center 85. In this regard, data center 85 might provide a gateway or web interface through which aspects of its operation may be configured through the use of a web browser application program executing on user computer 72. Alternately, a stand-alone application program executing on user computer 72 might access an application programming interface (API) exposed by data center 85 for performing the configuration operations. Other mechanisms for configuring the operation of various web services available at data center 85 might also be utilized.

Servers 76 shown in FIG. 11 may be servers configured appropriately for providing the computing resources described above and may provide computing resources for executing one or more web services and/or applications. In one embodiment, the computing resources may be virtual machine instances 78. In the example of virtual machine instances, each of the servers 76 may be configured to execute an instance manager 80a or 80b (which may be referred herein singularly as instance manager 80 or in the plural as instance managers 80) capable of executing the virtual machine instances 78. The instance managers 80 may be a virtual machine monitor (VMM) or another type of program configured to enable the execution of virtual machine instances 78 on server 76, for example. As discussed above, each of the virtual machine instances 78 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 85 shown in FIG. 11, a router 71 may be utilized to interconnect the servers 76a and 76b. Router 71 may also be connected to gateway 74, which is connected to communications network 73. Router 71 may be connected to one or more load balancers, and alone or in combination may manage communications within networks in data center 85, for example, by forwarding packets or other data communications as appropriate based on characteristics of such communications (e.g., header information including source and/or destination addresses, protocol identifiers, size, processing requirements, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example data center 85 shown in FIG. 11, a server manager 75 is also employed to at least in part direct various communications to, from and/or between servers 76a and 76b. While FIG. 11 depicts router 71 positioned between gateway 74 and server manager 75, this is merely an exemplary configuration. In some cases, for example, server manager 75 may be positioned between gateway 74 and router 71. Server manager 75 may, in some cases, examine portions of incoming communications from user computers 72 to determine one or more appropriate servers 76 to receive and/or process the incoming communications. Server manager 75 may determine appropriate servers to receive and/or process the incoming communications based on factors such as an identity, location or other attributes associated with user computers 72, a nature of a task with which the communications are associated, a priority of a task with which the communications are associated, a duration of a task with which the communications are associated, a size and/or estimated resource usage of a task with which the communications are associated and many other factors. Server manager 75 may, for example, collect or otherwise have access to state information and other information associated with various tasks in order to, for example, assist in managing communications and other operations associated with such tasks.

It should be appreciated that the network topology illustrated in FIG. 11 has been greatly simplified and that many more networks and networking devices may be utilized to interconnect the various computing systems disclosed herein. These network topologies and devices should be apparent to those skilled in the art.

It should also be appreciated that data center 85 described in FIG. 11 is merely illustrative and that other implementations might be utilized. It should also be appreciated that a server, gateway or other computing device may comprise any combination of hardware or software that can interact and perform the described types of functionality, including without limitation: desktop or other computers, database servers, network storage devices and other network devices, PDAs, tablets, cellphones, wireless phones, pagers, electronic organizers, Internet appliances, television-based systems (e.g., using set top boxes and/or personal/digital video recorders) and various other consumer products that include appropriate communication capabilities.

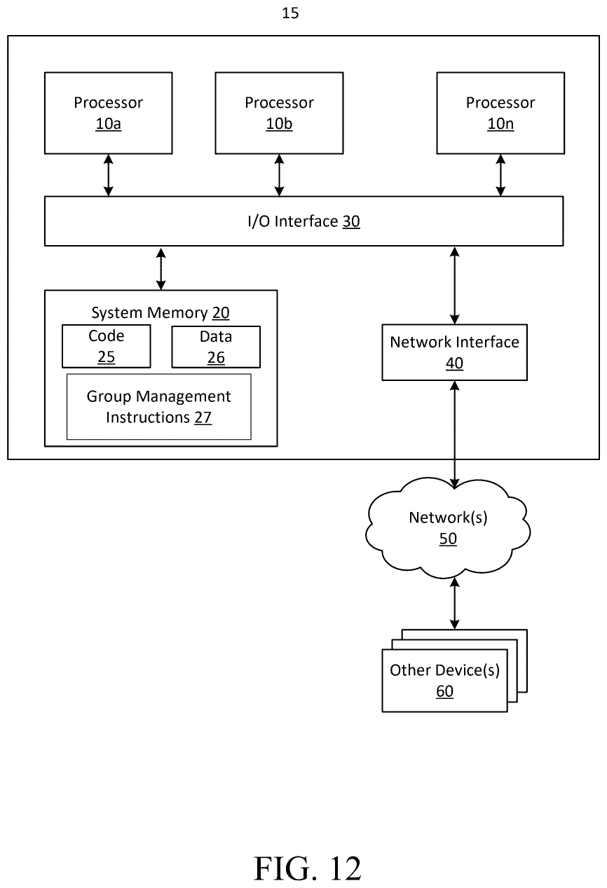

In at least some embodiments, a server that implements a portion or all of one or more of the technologies described herein may include a computer system that includes or is configured to access one or more computer-accessible media. FIG. 12 depicts a computer system that includes or is configured to access one or more computer-accessible media. In the illustrated embodiment, computing device 15 includes one or more processors 10a, 10b and/or 10n (which may be referred herein singularly as “a processor 10” or in the plural as “the processors 10”) coupled to a system memory 20 via an input/output (I/O) interface 30. Computing device 15 further includes a network interface 40 coupled to I/O interface 30.

In various embodiments, computing device 15 may be a uniprocessor system including one processor 10 or a multiprocessor system including several processors 10 (e.g., two, four, eight or another suitable number). Processors 10 may be any suitable processors capable of executing instructions. For example, in various embodiments, processors 10 may be embedded processors implementing any of a variety of instruction set architectures (ISAs), such as the x86, PowerPC, SPARC or MIPS ISAs or any other suitable ISA. In multiprocessor systems, each of processors 10 may commonly, but not necessarily, implement the same ISA.

System memory 20 may be configured to store instructions and data accessible by processor(s) 10. In various embodiments, system memory 20 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 20 as code 25 and data 26. Additionally, in this example, system memory 20 includes group management instructions 27, which are instructions for executing any, or all, of the HCI group related techniques described above, for example including implementation of stream preview and/or multi-application HCI group features.

In one embodiment, I/O interface 30 may be configured to coordinate I/O traffic between processor 10, system memory 20 and any peripherals in the device, including network interface 40 or other peripheral interfaces. In some embodiments, I/O interface 30 may perform any necessary protocol, timing or other data transformations to convert data signals from one component (e.g., system memory 20) into a format suitable for use by another component (e.g., processor 10). In some embodiments, I/O interface 30 may include support for devices attached through various types of peripheral buses, such as a variant of the Peripheral Component Interconnect (PCI) bus standard or the Universal Serial Bus (USB) standard, for example. In some embodiments, the function of I/O interface 30 may be split into two or more separate components, such as a north bridge and a south bridge, for example. Also, in some embodiments some or all of the functionality of I/O interface 30, such as an interface to system memory 20, may be incorporated directly into processor 10.

Network interface 40 may be configured to allow data to be exchanged between computing device 15 and other device or devices 60 attached to a network or networks 50, such as other computer systems or devices, for example. In various embodiments, network interface 40 may support communication via any suitable wired or wireless general data networks, such as types of Ethernet networks, for example. Additionally, network interface 40 may support communication via telecommunications/telephony networks, such as analog voice networks or digital fiber communications networks, via storage area networks such as Fibre Channel SANs (storage area networks) or via any other suitable type of network and/or protocol.

In some embodiments, system memory 20 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media—e.g., disk or DVD/CD coupled to computing device 15 via I/O interface 30. A non-transitory computer-accessible storage medium may also include any volatile or non-volatile media, such as RAM (e.g., SDRAM, DDR SDRAM, RDRAM, SRAM, etc.), ROM (read only memory) etc., that may be included in some embodiments of computing device 15 as system memory 20 or another type of memory. Further, a computer-accessible medium may include transmission media or signals such as electrical, electromagnetic or digital signals conveyed via a communication medium, such as a network and/or a wireless link, such as those that may be implemented via network interface 40.

A network set up by an entity, such as a company or a public sector organization, to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment and the like, needed to implement and distribute the infrastructure and web services offered by the provider network. The resources may in some embodiments be offered to clients in various units related to the web service, such as an amount of storage capacity for storage, processing capability for processing, as instances, as sets of related services and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

A number of different types of computing devices may be used singly or in combination to implement the resources of the provider network in different embodiments, for example computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (JVMs), general-purpose or special-purpose operating systems, platforms that support various interpreted or compiled programming languages such as Ruby, Perl, Python, C, C++ and the like or high-performance computing platforms) suitable for the applications, without, for example, requiring the client to access an instance or an execution platform directly. A given execution platform may utilize one or more resource instances in some implementations; in other implementations, multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as computing instances. In some examples, a computing instance may represent a physical server hardware platform, a virtual machine instance executing on a server or some combination of the two. A host computing instance is a computing instance that hosts execution of hostable computing features, such as one or more applications.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability container of a resource instance is intended to be independent of the availability container of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

As set forth above, content may be provided by a content provider to one or more clients. The term content, as used herein, refers to any presentable information, and the term content item, as used herein, refers to any collection of any such presentable information. A content provider may, for example, provide one or more content providing services for providing content to clients. The content providing services may reside on one or more servers. The content providing services may be scalable to meet the demands of one or more customers and may increase or decrease in capability based on the number and type of incoming client requests. Portions of content providing services may also be migrated to be placed in positions of reduced latency with requesting clients. For example, the content provider may determine an “edge” of a system or network associated with content providing services that is physically and/or logically closest to a particular client. The content provider may then, for example, “spin-up,” migrate resources or otherwise employ components associated with the determined edge for interacting with the particular client. Such an edge determination process may, in some cases, provide an efficient technique for identifying and employing components that are well suited to interact with a particular client, and may, in some embodiments, reduce the latency for communications between a content provider and one or more clients.

In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed is:

1. A computing system comprising:
one or more processors; and
one or more memories having stored therein instructions that, upon execution by the one or more processors, cause the computing system to perform operations comprising:
receiving, by a video game streaming service, from a customer, one or more requests to link a plurality of different video games to a host computing instance group for hosting execution of the plurality of different video games;
receiving a request for video game instance placement for a user for a first video game of the plurality of different video games;
determining, by the video game streaming service, based on a set of priorities, a selected video game instance of the first video game on which to place the user, wherein the set of priorities comprises a first priority to place the user onto an existing video game instance of the first video game that is already loaded, a second priority to place the user onto a new video game instance of the first video game and to load the new video game instance on a host computing instance of the host computing instance group that has already loaded at least one other video game instance and that has sufficient available space for a video game size of the first video game, and a third priority to place the user onto the new video game instance and to load the new video game instance on a host computing instance of the host computing instance group that has not already loaded at least one other video game instance, wherein the first priority is employed when the first priority satisfiable, wherein the second priority is employed when the second priority is satisfiable and the first priority is not satisfiable, and wherein the third priority is employed when the third priority is satisfiable and when both the first priority and the second priority are not satisfiable; and
transmitting, by the video game streaming service, a video stream captured from the selected video game instance to the user.

2. The computing system of claim 1, further comprising:
transmitting, by the video game streaming service, an audio stream captured from the selected video game instance to the user.

3. The computing system of claim 1, wherein at least two of the plurality of different video games are different video game titles.

4. The computing system of claim 1, wherein at least two of the plurality of different video games are different versions of a same video game title.

5. A computer-implemented method comprising:
receiving, by an application streaming service, from a customer, one or more requests to link a plurality of different applications to a host computing instance group for hosting execution of the plurality of different applications;
receiving a request for application instance placement for a user for a first application of the plurality of different applications;
determining, by the application streaming service, based on a set of priorities, a selected application instance of the first application on which to place the user, wherein the set of priorities comprises a first priority to place the user onto an existing application instance of the first application that is already loaded, a second priority to place the user onto a new application instance of the first application and to load the new application instance on a host computing instance of the host computing instance group that has already loaded at least one other application instance and that has sufficient available space for an application size of the first application, and a third priority to place the user onto the new application instance and to load the new application instance on a host computing instance of the host computing instance group that has not already loaded at least one other application instance, wherein the first priority is employed when the first priority satisfiable, wherein the second priority is employed when the second priority is satisfiable and the first priority is not satisfiable, and wherein the third priority is employed when the third priority is satisfiable and when both the first priority and the second priority are not satisfiable; and
transmitting, by the application streaming service, a video stream captured from the selected application instance to the user.

6. The computer-implemented method of claim 5, wherein the first application is a video game.

7. The computer-implemented method of claim 5, wherein the determining of the selected application instance on which to place the user comprises:
determining that the first priority is satisfiable; and
determining to place the user on the existing application instance.

8. The computer-implemented method of claim 5, wherein the determining of the selected application instance on which to place the user comprises:
determining that the first priority is not satisfiable and that the second priority is satisfiable; and
determining to place the user on the new application instance and to load the new application instance on the host computing instance that has already loaded at least one other application instance and that has sufficient available space for the application size of the first application.

9. The computer-implemented method of claim 5, wherein the determining of the selected application instance on which to place the user comprises:
determining that both the first priority and the second priority are not satisfiable and that the third priority is satisfiable; and
determining to place the user on the new application instance and to load the new application instance on the host computing instance that has not already loaded at least one other application instance.

10. The computer-implemented method of claim 5, further comprising:
transmitting, by the application streaming service, an audio stream captured from the selected application instance to the user.

11. The computer-implemented method of claim 5, wherein at least two of the plurality of different applications are different application titles.

12. The computer-implemented method of claim 5, wherein at least two of the plurality of different applications are different versions of a same application title.

13. One or more non-transitory computer-readable storage media having stored thereon computing instructions that, upon execution by one or more computing devices, cause the one or more computing devices to perform operations comprising:
receiving, by an application streaming service, from a customer, one or more requests to link a plurality of different applications to a host computing instance group for hosting execution of the plurality of different applications;
receiving a request for application instance placement for a user for a first application of the plurality of different applications;
determining, by the application streaming service, based on a set of priorities, a selected application instance of the first application on which to place the user, wherein the set of priorities comprises a first priority to place the user onto an existing application instance of the first application that is already loaded, a second priority to place the user onto a new application instance of the first application and to load the new application instance on a host computing instance of the host computing instance group that has already loaded at least one other application instance and that has sufficient available space for an application size of the first application, and a third priority to place the user onto the new application instance and to load the new application instance on a host computing instance of the host computing instance group that has not already loaded at least one other application instance, wherein the first priority is employed when the first priority satisfiable, wherein the second priority is employed when the second priority is satisfiable and the first priority is not satisfiable, and wherein the third priority is employed when the third priority is satisfiable and when both the first priority and the second priority are not satisfiable; and
transmitting, by the application streaming service, a video stream captured from the selected application instance to the user.

14. The one or more non-transitory computer-readable storage media of claim 13, wherein the first application is a video game.

15. The one or more non-transitory computer-readable storage media of claim 13, wherein the determining of the selected application instance on which to place the user comprises:
determining that the first priority is satisfiable; and
determining to place the user on the existing application instance.

16. The one or more non-transitory computer-readable storage media of claim 13, wherein the determining of the selected application instance on which to place the user comprises:
determining that the first priority is not satisfiable and that the second priority is satisfiable; and
determining to place the user on the new application instance and to load the new application instance on the host computing instance that has already loaded at least one other application instance and that has sufficient available space for the application size of the first application.

17. The one or more non-transitory computer-readable storage media of claim 13, wherein the determining of the selected application instance on which to place the user comprises:
determining that both the first priority and the second priority are not satisfiable and that the third priority is satisfiable; and
determining to place the user on the new application instance and to load the new application instance on the host computing instance that has not already loaded at least one other application instance.

18. The one or more non-transitory computer-readable storage media of claim 13, further comprising:
transmitting, by the application streaming service, an audio stream captured from the selected application instance to the user.

19. The one or more non-transitory computer-readable storage media of claim 13, wherein at least two of the plurality of different applications are different application titles.

20. The one or more non-transitory computer-readable storage media of claim 13, wherein at least two of the plurality of different applications are different versions of a same application title.
